(19) United States
(12) Patent Application Publication
(10) Pub. No.: US 2022/0198356 A1
(43) Pub. Date: Jun. 23, 2022

(54) SYSTEM AND METHOD FOR PRODUCT REARRANGEMENT IN RETAIL ENVIRONMENT BASED ON POSITION ADJACENCY AWARENESS PLAN

(71) Applicant: INFILECT TECHNOLOGIES PRIVATE LIMITED, Bengaluru (IN)

(72) Inventors: Vijay Gabale, Bengaluru (IN); Anand Prabhu Subramanian, Bengaluru (IN)

(21) Appl. No.: 17/605,208

(22) PCT Filed: Apr. 24, 2020
(86) PCT No.: PCT/IN2020/050382

§ 371 Date: Oct. 20, 2021

(30) Foreign Application Priority Data
Apr. 24, 2019 (IN) 2019-41016175

(51) Int. Cl. G06Q 10/06; G06Q 30/02; G06N 3/08; G06T 7/70; G06V 20/50; G06V 10/82; G06T 17/00

(52) U.S. Cl. CPC G06Q 10/06315; G06Q 30/0201; G06N 3/08; G06T 2207/20084; G06V 20/50; G06V 10/82; G06T 17/00; G06T 7/70

(57) ABSTRACT

A system for recognizing a plurality of assets in an environment, determining a distribution of the plurality of assets, computing a position adjacency constraint for the distribution of the plurality of assets and a rearrangement plan based on position adjacency constraints for the plurality of assets in the environment is provided. The system (i) determines a distribution of a plurality of assets and type of each of the plurality of assets within the media content, (ii) determines a brand and at least one object from the brand associated with each of the plurality of assets, (iii) determines at least one attribute of the at least one determined object associated with the brand, (iv) computes a position adjacency constraints for the distribution of the plurality of assets and (v) computes a rearrangement plan for the plurality of assets within the environment based on the computed position adjacency constraint and compliance rules.

### BACKGROUND

### Technical Field

The embodiments herein generally relate to a system and method for recognizing and analyzing one or more assets in an environment to optimize inventory in the environment by using neuromarketing or shopper psychology principles, and more specifically to a system and method for merchandizing retail space in an environment based on creating position adjacency constraints between competitive and visually similar assets and a position adjacency awareness plan for the placement of assets in the environment.

### Description of the Related Art

Effective inventory control is a critical factor that determines the success of any retail business. Though manufacturers spend a large amount of money towards framing effective marketing strategies by means of advertisements and purchasing display space in a retail store for their product displays, the success of marketing greatly depends on how their products are merchandised on retail space. The placement of competitive brands adjacent to each other in a retail shelf greatly influences the buying decision of a buyer at a point of sale. Similarly, a buyer who decides a buy a particular brand, may buy a brand similar to the brand of his interest due to time constraints at the point of sale. Hence, any CPG (consumer packaged goods) company does not like to have competing products of other brands and visually similar looking products of other brands displayed adjacently in the same row or adjacent rows to their own products in a retail shelf. This challenge is vested upon a merchandiser, who rearrange the products to suit this requirement.

It is very difficult and cumbersome for a merchandiser to identify which two brands are competitive on a real-time basis, as two products might not be competitive forever and organize SKUs (Stock Keeping Units) into different rows and columns of retails shelves based on position-adjacency awareness. Further, manual identification of competitive and visually similar products is time-consuming and the decisions will be inaccurate to frame an effective merchandising strategy for the products at the point of sale.

Accordingly, there remains a need for an automated system and method for recognizing a plurality of assets in an environment, determining a distribution of the plurality of assets, computing a position adjacency constraint for the distribution of the plurality of assets and computing rearrangement plan based on the computed position adjacency constraints for the plurality of assets in the environment.

### SUMMARY

In view of the foregoing, an embodiment herein provides a processor-implemented method for recognizing a plurality of assets in an environment, determining a distribution of the plurality of assets, computing a position adjacency constraint for the distribution of the plurality of assets and computing a rearrangement plan based on the position adjacency constraints for the plurality of assets in the environment. The method includes steps of: (i) generating a database with a media content associated with an environment; (ii) determining a distribution of a plurality of assets within the media content associated with the environment; (iii) determining a type of each of the plurality of assets within the media content, (iv) determining, using a deep neural networking model, a brand from each of the plurality of assets; (v) determining at least one object from the brand associated with each of the plurality of assets; (vi) determining at least one attribute of the at least one determined object associated with the brand within the environment using the deep neural networking model; (vii) implementing at least one compliance rule to the at least one attribute of the at least one object to determine at least one of a placement of the brand in the asset, a placement of the brand along with other brands in the asset, a number of words in the text, a size of the brand logo or the brand name, a location of the brand logo or the brand name, a color contrast of the brand with respect to the environment, or a distinctness of the brand; (viii) computing a position adjacency constraint for the distribution of the plurality of assets within the environment by (a) determining two competing brands based on a brand taxonomy; (b) determining two visually similar brands using an unsupervised neural network model and computing a similarity-score for the two visually similar brands. The similarity-score is computed by determining the distance/angle between the corresponding n-bit/float vectors of the two visually similar brands within the media content; (c) introducing a position-separation constraint of least one row apart or at least one column apart of the two competing brands and the visually similar brands. The position-separation constraint is encoded as a mathematical formulation by modeling each position as a binary variable and (ix) computing a rearrangement plan for the plurality of assets within the environment based on the computed position adjacency constraint and the compliance rules.

In some embodiments, the media content is captured using a camera or a virtual reality device and the media content includes at least one of an image of an asset, a video of an asset or a three-dimensional model of at least one of a physical retail store environment, a digital retail store environment, a virtual reality store environment, a social media environment or a web page environment.

In some embodiments, the at least one object comprises at least one of a brand name, a brand logo, a text, a product, or a brand-specific object. In some embodiments, the deep neural networking model is trained using a plurality of design creatives taken at a plurality of instances corresponding to a plurality of brands. In some embodiments, the at least one attribute comprises a color, a color contrast, a location of the object, a text size, or a number of words in the text.

In some embodiments, the at least one compliance rule includes at least one of a placement compliance rule, a location compliance rule, a text compliance rule, a color compliance rule, or a size compliance rule. In some embodiments, the attention sequence includes a sequence number for one or more pixel in the media content and the heatmap includes heat for one or more different color of the one or more pixels in the media content.

In some embodiments, the media content comprising the video of the asset or the video of at least one of the physical retail store environments, the digital retail store environment, the virtual reality store environment, the social media environment or the web page environment is parsed to extract one or more images.

In some embodiments, the media content is converted into a three-dimensional model, when the media content is received from the digital retail store environment or the virtual reality store environment.

In some embodiments, the media content comprises an image or a video or three-dimensional model associated with at least one of an inside or an outside of the environment.

In some embodiments, the brand taxonomy is created by collecting information from organization/brand web pages.

In some embodiments, the unsupervised neural network model comprises an auto-encoder to compute a fixed-length representation of the 3D/2D model/photo of each product in terms of n-bit/float vectors for calculating the similarity score.

In one aspect, one or more non-transitory computer readable storage mediums storing instructions, which when executed by a processor, a method of automatic recognition of a plurality of assets in an environment using an image recognition technique, determining a distribution of the plurality of assets, computing a position adjacency constraints for the distribution of the plurality of assets and a rearrangement plan based on the position adjacency constraints for the plurality of assets in the environment is provided. The method includes the steps of: (i) generating a database with a media content associated with an environment; (ii) determining a distribution of a plurality of assets within the media content associated with the environment; (iii) determining a type of each of the plurality of assets within the media content; (iv) determining, using a deep neural networking model, a brand from each of the plurality of assets;, (v) determining at least one object from the brand associated with each of the plurality of assets; (vi) determining at least one attribute of the at least one determined object associated with the brand within the environment using the deep neural networking model; (vii) implementing at least one compliance rule to the at least one attribute of the at least one object to determine at least one of a placement of the brand in the asset, a placement of the brand along with other brands in the asset, a number of words in the text, a size of the brand logo or the brand name, a location of the brand logo or the brand name, a color contrast of the brand with respect to the environment, or a distinctness of the brand; (viii) computing a position adjacency constraint for the distribution of the plurality of assets within the environment by (a) determining two competing brands based on a brand taxonomy; (b) determining two visually similar brands using an unsupervised neural network model and computing a similarity-score for the two visually similar brands. The similarity-score is computed by determining the distance/angle between the corresponding n-bit/float vectors of the two visually similar brands within the media content; (c) introducing a position-separation constraint of least one row apart or at least one column apart of the two competing brands and the visually similar brands. The position-separation constraint is encoded as a mathematical formulation by modeling each position as a binary variable and (ix) computing a rearrangement plan for the plurality of assets within the environment based on the computed position adjacency constraint and the compliance rules.

In some embodiments, the media content is captured using a camera or a virtual reality device and the media content includes at least one of an image of an asset, a video of an asset or a three-dimensional model of at least one of a physical retail store environment, a digital retail store environment, a virtual reality store environment, a social media environment or a web page environment.

In some embodiments, the at least one object comprises at least one of a brand name, a brand logo, a text, a product, or a brand-specific object. In some embodiments, the deep neural networking model is trained using a plurality of design creatives taken at a plurality of instances corresponding to a plurality of brands. In some embodiments, the at least one attribute comprises a color, a color contrast, a location of the object, a text size, or a number of words in the text.

In some embodiments, the at least one compliance rule includes at least one of a placement compliance rule, a location compliance rule, a text compliance rule, a color compliance rule, or a size compliance rule. In some embodiments, the attention sequence includes a sequence number for one or more pixel in the media content and the heatmap includes heat for one or more different color of the one or more pixels in the media content.

In some embodiments, the media content comprising the video of the asset or the video of at least one of the physical retail store environments, the digital retail store environment, the virtual reality store environment, the social media environment or the web page environment is parsed to extract one or more images.

In some embodiments, the media content is converted into a three-dimensional model, when the media content is received from the digital retail store environment or the virtual reality store environment.

In some embodiments, the media content comprises an image or a video or three-dimensional model associated with at least one of an inside or an outside of the environment.

In some embodiments, the brand taxonomy is created by collecting information from organization/brand web pages.

In some embodiments, the unsupervised neural network model comprises an auto-encoder to compute a fixed-length representation of the 3D/2D model/photo of each product in terms of n-bit/float vectors for calculating the similarity score.

In another aspect, a system for automatically recognizing a plurality of assets in an environment using an image recognition technique, determining a distribution of the plurality of assets, computing a position adjacency constraint for the distribution of the plurality of assets and a rearrangement plan based on the position adjacency constraints for the plurality of assets in the environment is provided. The system includes a memory, and a device processor. The memory includes a database that stores a media content associated with the environment. The media content is captured using a camera or a virtual reality device. The media content includes at least one of an image of an asset, a video of an asset or a three-dimensional model of at least one of a physical retail store environment, a digital retail store environment, a virtual reality store environment, a social media environment or a web page environment. The database stores one or more modules are executable by the device processor. The set of modules includes (i) a database generation module that generates a database of media content associated with the environment; (ii) an asset determination module that determines (a) a distribution of a plurality of assets within the media content associated with the environment, and (b) a type of each of the plurality of assets within the media content; (iii) a brand determination module that determines a brand from each of the plurality of assets using a deep neural network model; (iv) an object recognition module that determines at least one object from the brand associated with each of the plurality of assets; (v) an attribute determination module that determines at least one attribute of the at least one determined object associated with the brand within the environment using the deep neural networking model; (vi) a compliance rule implementation module that implements at least one compliance rule to the at least one attribute of the at least one object to determine at least one of a placement of the brand in the asset, a placement of the brand along with other brands in the asset, a number of words in the text, a size of the brand logo or the brand name, a location of the brand logo or the brand name, a color contrast of the brand with respect to the environment, or a distinctness of the brand; (vii) a position adjacency constraint computation module that computes a position adjacency constraints for the distribution of the plurality of assets by (a) determining two competing brands based on a brand taxonomy. The competing brands have a common ancestor in the taxonomy; (b) determining two visually similar brands using an unsupervised neural network model and computing a similarity-score for the two visually similar brands. The similarity-score is computed by determining the distance/angle between the corresponding n-bit/float vectors of the two visually similar brands within the media content; (c) introducing a position-separation constraint of least one row apart or at least one column apart of the two competing brands and the visually similar brands. The position-separation constraint is encoded as a mathematical formulation by modeling each position as a binary variable, and (viii) a rearrangement plan computation module that computes a rearrangement plan for the plurality of assets within the environment based on the computed position adjacency constraint and the compliance rules.

The media content may be captured using a camera or a virtual reality device, wherein the media content comprises at least one of an image of an asset, a video of an asset, a shelf brand display, a point of sale brand display, a digital advertisement displays or an image, a video or a three-dimensional model of at least one of a physical retail store environment, a digital retail store environment, a virtual reality store environment, a social media environment or a web page environment. In some embodiments, the at least one object comprises at least one of a brand name, a brand logo, a text, a product or a brand-specific object. In some embodiments, the deep neural networking model is trained using one or more design creatives taken at one or more instances corresponding to one or more brands. In some embodiments, the at least one attribute includes a color, a color contrast, a location of the object, a text size, or a number of words in the text. In some embodiments, the at least one of a placement compliance rule, a location compliance rule, a text compliance rule, a color compliance rule, or a size compliance rule. In some embodiments, the attention sequence includes a sequence number for one or more pixel in the media content and the heatmap includes heat for one or more different color of the one or more pixels in the media content.

In some embodiments, the one or more modules comprises a parsing module that automatically extracts a plurality of images by parsing the media content when the media content comprises the video of the asset or the video of at least one of the physical retail store environments, the digital retail store environment, the virtual reality store environment, the social media environment or the web page environment.

In some embodiments, the media content is converted into a three-dimensional model when the media content is received from the digital retail store environment or the virtual reality store environment.

In some embodiments, the brand taxonomy is created by collecting information from organization/brand web pages.

In some embodiments, the unsupervised neural network model comprises an auto-encoder to compute a fixed-length representation of the 3D/2D model/photo of each product in terms of n-bit/float vectors for calculating the similarity score.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view a product rearrangement system based on a position adjacency awareness plan according to an embodiment herein;

FIG. 2 is an exploded view of the product rearrangement system 106 of FIG. 1 according to an embodiment herein;

FIG. 3A and FIG. 3B are flow diagrams that illustrate a method of rearranging product in a retail environment using the product rearrangement system of FIG. 1 according to an embodiment herein; and

FIG. 4 is a schematic diagram of a computer architecture in accordance with the embodiments herein.

### DETAILED DESCRIPTION OF THE DRAWINGS

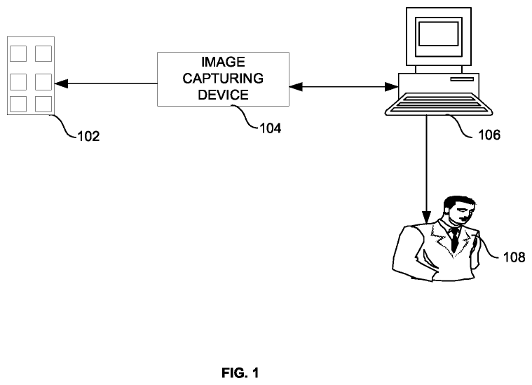

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein. Various embodiments disclosed herein provide a system and a method for recognizing and analyzing a plurality of objects in a design creative to generate a modified design creative based on the heatmaps and the attention sequence corresponding to the design creative. Referring now to the drawings, and more particularly to FIGS. 1 through 4, where similar reference characters denote corresponding features consistently throughout the figures, preferred embodiments are shown.

FIG. 1 illustrates a system view a product rearrangement system based on a position adjacency awareness plan according to an embodiment herein. The system view includes an image capturing device 104, and the product rearrangement system based on a position adjacency awareness plan 106. The image capturing device 104 obtains the image of an environment 102. The product arrangement system 106 is communicatively connected to the image capturing device 104. The product rearrangement system 106 provides a product rearrangement plan for the plurality of assets associated with an environment based on a position adjacency awareness created by computing a position adjacency constraint for the distribution of the plurality of assets within the environment to a user 108. In one embodiment, the product rearrangement system 106 may be a mobile phone, a kindle, a PDA (Personal Digital Assistant), a tablet, a music player, a computer, an electronic notebook or a smartphone. The product rearrangement system 106 includes a memory and a processor. The image capturing device 104 captures media content from the environment. The product rearrangement system 106 generates a database of media content associated with the environment. In an embodiment, the media content includes at least one of an image of an asset, a video of an asset or a three-dimensional model of at least one of a physical retail store environment, a digital retail store environment, a virtual reality store environment, a social media environment or a web page environment. The product rearrangement system 106 determines a distribution of a plurality of assets and a type of each of the plurality of assets within the media content associated with the environment. The product rearrangement system 106 includes a deep neural networking model to determine a brand from each of the plurality of assets and determines at least one object from the brand associated with each of the plurality of assets. The product rearrangement system 106 determines at least one attribute of the at least one determined object associated with the brand within the environment using a deep neural networking model. The at least one object may include at least one of a brand name, a brand logo, a text, a product or a brand-specific object. The at least one attribute may include a color, a color contrast, a location of the object, a text size, or a number of words in the text. The product rearrangement system 106 computes a position adjacency constraints for the distribution of the plurality of assets within the environment, which include (a) determining two competing brands based on a brand taxonomy (b) determining visually similar brands and computing a similarity-score for the two visually similar brands, introducing a position-separation constraint of least one row apart or at least one column apart of the two competing brands and the visually similar brands and computing the product rearrangement plan based on the position-separation constraint and compliance rules.

In an embodiment, the media content comprising the video of the asset or the video of at least one of the physical retail store environments, the digital retail store environment, the virtual reality store environment, the social media environment or the web page environment is parsed to extract one or more images.

In an embodiment, the neural networking model is a machine learning technique that is designed to recognize and interpret the data through a machine perception, a labeling and by clustering the raw data. The neural networking model is trained to interpret the raw data by providing a collection of data as an input. The neural networking model is trained to perform the task with the processor.

In an embodiment, the determination of a location of a plurality of assets and a type of each of the plurality of assets within the media content associated with the environment is through image recognition technique using the deep neural network model.

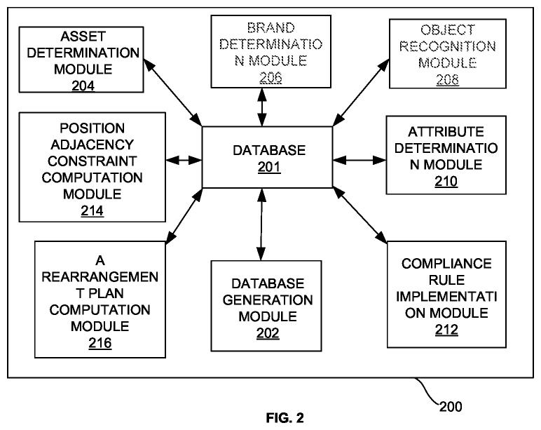

FIG. 2 is an exploded view of the product rearrangement system 106 of FIG. 1 according to an embodiment herein. The product rearrangement system 106 includes a database 201, a database generation module 202, an asset determination module 204, a brand determination module 206, an object recognition module 208, an attribute determination module 210, a compliance rule implementation module 212, a position adjacency constraint computation module 214 and a rearrangement plan computation module 216. The product rearrangement system 106 receives a media content to analyze and recognize the plurality of assets in an environment within the media content. The media content may be stored in the database 201 of a memory. The database generation module 202 generates the database 201 with media content associated with the environment. In an embodiment, the media content is captured using a camera or a virtual reality device. The media content may include at least one of an image of an asset, a video of an asset or a three-dimensional model of at least one of a physical retail store environment, a digital retail store environment, a virtual reality store environment, a social media environment or a web page environment. The asset determination module 204 determines (i) a distribution of a plurality of assets within the media content associated with the environment, and (ii) a type of each of the plurality of assets within the media content. The brand determination module 206 determines a brand from each of the plurality of assets using a deep neural networking model. The object recognition module 208 determines at least one object from the brand associated with each of the plurality of assets. The at least one object includes at least one of a brand name, a brand logo, a text, a product or a brand-specific object. The deep neural networking model is trained using a plurality of design creatives taken at a plurality of instances corresponding to a plurality of brands. The attribute determination module 210 determines at least one attribute of the at least one determined object associated with the brand within the environment using the deep neural networking model. In an embodiment, the at least one attribute includes a color, a color contrast, a location of the object, a text size, or a number of words in the text. The compliance rule implementation module 212 implements at least one compliance rule to the at least one attribute of the at least one object to determine at least one of a placement of the brand in the asset, a placement of the brand along with other brands in the asset, a number of words in the text, a size of the brand logo or the brand name, a location of the brand logo or the brand name, a color contrast of the brand with respect to the environment, or a distinctness of the brand. In an embodiment, the at least one compliance rule comprises a placement compliance rule, a location compliance rule, a text compliance rule, a color compliance rule, or a size compliance rule. The position adjacency constraint computation module 214 computes position adjacency constraints for the distribution of the plurality of assets includes (a) determining two competing brands based on a brand taxonomy. The competing brands have a common ancestor in the taxonomy; (b) determining two visually similar brands using an unsupervised neural network model and computing a similarity-score for the two visually similar brands; (c) introducing a position-separation constraint of least one row apart or at least one column apart of the two competing brands and the visually similar brands. The position-separation constraint is encoded as a mathematical formulation by modeling each position as a binary variable. The rearrangement plan computation module 216 computes a rearrangement plan for the plurality of assets within the environment based on the position adjacency constraint and the compliance rules.

In an embodiment, the one or more modules comprises a parsing module that automatically extracts a plurality of images by parsing the media content when the media content comprises the video of the asset or the video of at least one of the physical retail store environments, the digital retail store environment, the virtual reality store environment, the social media environment or the web page environment. In an embodiment, the asset determination module 204 determines (i) a location of a plurality of assets within the media content associated with the environment, and (ii) a type of each of the plurality of assets within the media content through image recognition technique using the deep neural network model.

In an embodiment, the brand determination module 206 uses the deep neural networking model to recognize a brand from each of the plurality of assets. The neural networking model has trained a plurality of design creatives taken at a plurality of instances corresponding to a plurality of brands. In another embodiment, the plurality of instances includes images of the design creative taken from a plurality of angles. The plurality of angles includes a front view, a back view, a rear view and a side view of the design creative.

In another embodiment, the attribute determination module 210 detects and recognizes at least one attribute of the at least one determined object associated with the brand within the environment. The at least one attribute includes a color of the detected object associated with the brand or a color of the brand, a color contrast of the detected object associated with the brand in context of the color of the corresponding brand on which the object is detected, a location of the detected object associated with the brand, a size of the object and number of words in the object when the object is a text. In an embodiment, the compliance rule implementation module 212 determines whether the recognized attribute of the object is in accordance with the standard marketing rules. The compliance rule includes a placement compliance rule, a location compliance rule, a text compliance rule, a color compliance rule, or a size compliance rule. In one embodiment, the text compliance determines whether a size and a number of words in the text are in accordance with the marketing rules. The size compliance may determine whether a size of the plurality of objects associated with the brand is in accordance with the marketing rules. The color compliance may determine whether a color of the detected object associated with the brand or the color of the brand and the color contrast of the detected object associated with the brand in the context of the color of the corresponding brand on which the object is detected is in accordance with the marketing rules. The location compliance may determine whether a location of the detected object associated with the brand is in accordance with the marking rules. The placement compliance may determine whether a placement of the brand associated with each of the plurality of assets is in accordance with the marketing rules.

The compliance rule implementation module 212 determines an effectiveness and a distinctiveness of the brand associated with each of the plurality of assets with respect to the environment in which it is placed.

In an embodiment, the rearrangement plan computation module 216 automatically computes a rearrangement plan for the plurality of assets within the environment. The rearrangement plan is presented to the user 108 for rearranging the assets within the environment based on the position-separation constraint and the compliance rules. The user 108 may access the rearrangement plan for rearranging the assets within the environment through an interface associated with the user's device. In an embodiment, the position adjacency constraint computation module 214 creates position adjacency constraints based on competitive and similarity scores for a given distribution of assets within the environment as per market share of the asset.

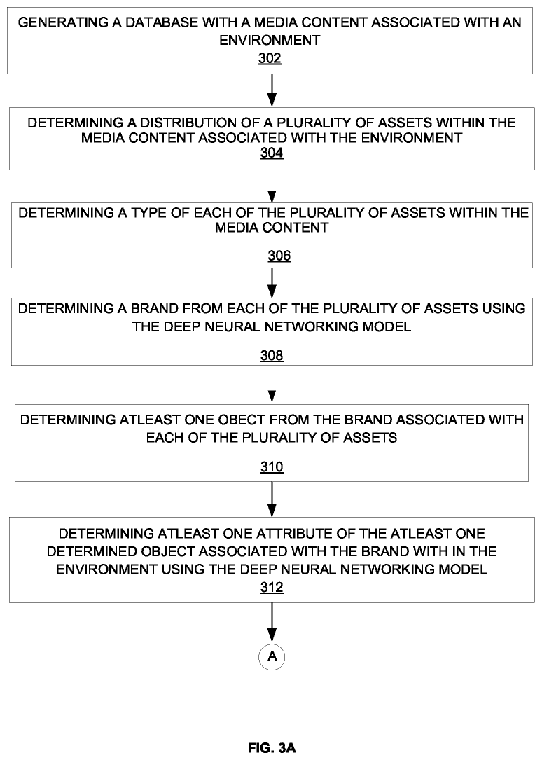

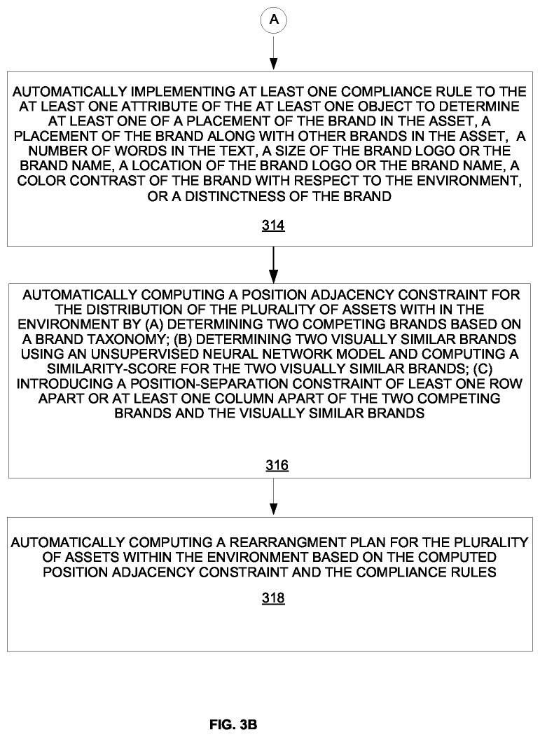

FIG. 3A and FIG. 3B are flow diagrams that illustrate a method of rearranging product in a retail environment using the product rearrangement system of FIG. 1 according to an embodiment herein. At step 302, a database of a media content associated with an environment is generated. At step 304, a distribution of the plurality of assets within the media content associated with the environment is determined. At step 306, a type of each of the plurality of assets within the media content is determined. At step 308, a brand from each of the plurality of asset is determined using the deep neural networking model. At step 310, the at least one object from the brand associated with each of the plurality of assets is determined. At step 312, the at least one attribute of the at least one determined object associated with the brand within the environment is determined using the deep neural networking model. At step 314, the at least one compliance rule is implemented to the at least one attribute of the at least one object to determine at least one of a placement of the brand in the asset, a placement of the brand along with other brands in the asset, a number of words in the text, a size of the brand logo or the brand name, a location of the brand logo or the brand name, a color contrast of the brand with respect to the environment, or a distinctness of the brand. At step 316, a position adjacency constraint for the distribution of the plurality of assets within the environment is computed. At step 318, a rearrangement plan for the plurality of assets within the environment based on the position adjacency constraint and the compliance rules is computed. The position adjacency constraint is computed by (a) determining two competing brands based on a brand taxonomy; (b) determining two visually similar brands using an unsupervised neural network model and computing a similarity-score for the two visually similar brands; (c) introducing a position-separation constraint of least one row apart or at least one column apart of the two competing brands and the visually similar brands.

In an embodiment, the media content is captured using a camera or a virtual reality device, wherein the media content comprises at least one of an image of an asset, a video of an asset or a three-dimensional model of at least one of a physical retail store environment, a digital retail store environment, a virtual reality store environment, a social media environment or a web page environment. The at least one object comprises at least one of a brand name, a brand logo, a text, a product, or a brand-specific object. The deep neural networking model may be trained using a one or more design creatives taken at one or more instances corresponding to one or more brands. The at least one attribute comprises a color, a color contrast, a location of the object, a text size, or a number of words in the text. The at least one compliance rule may include at least one of a placement compliance rule, a location compliance rule, a text compliance rule, a color compliance rule, or a size compliance rule. In an embodiment, the media content comprising the video of the asset or the video of at least one of the physical retail store environments, the digital retail store environment, the virtual reality store environment, the social media environment or the web page environment is parsed to extract a plurality of images. In an embodiment, the media content is converted into a three-dimensional model when the media content is received from the digital retail store environment or the virtual reality store environment. In an embodiment, the media content comprises an image or a video or three-dimensional model associated with at least one of an inside or an outside of the environment.

In an embodiment, the competing brands have a common ancestor in the taxonomy, which is a well-maintained CPG organization/brand taxonomy. The taxonomy is created by collecting information from organization/brand web pages. The taxonomy includes multiple levels that can be represented as an inverted tree-structure with root/parent node and multiple branches growing out of this root node as the tree expands downwards. At the last level of this tree/taxonomy, there will be individual SKUs listed represented as level L and the root node to be at the level represented as L 0. Level L represents SKU, Level L-1 represents brand form, Level L-2 represents the brand, Level L-3 represents fine-level consumer lifestyle category and level L-4 represents coarse-level consumer lifestyle category. If two SKUs/brand forms/brands have a common ancestor, they are referred to compete with each other and are considered as competing brands.

In an embodiment, an image recognition technique is used to compute a similarity-score between two products/brands. The image recognition technique works on the principle of unsupervised learning which includes an auto-encoder or variational auto-encoder is used to compute a fixed length (san-bit/float, n=256 values) representation of the 3D/2D model/photo of each product. With respect to given 2D models, or boxes around SKUs/products in a shelf picture, a distance metric which includes a cosine distance is used to compute distance/angle with between the corresponding n-bit/float vectors. If the distance is smaller, greater will be the similarity. A similarity score is computed based on the distance between the two vectors.

In an embodiment, the encoder including an encoder neural network is trained as a classification network, or as an auto-encoder or a variation of auto-encoder, or as a siamese network with a contrastive loss or triplet loss method. The neural network takes a photo as input and passes it through a set of neural computation layers. A layer at the end called a fully connected layer, produces a fixed n bit/float vector representation of 1024 values. The layers in between could be convolution, ReLU, max pooling, normalization, fully connected layers typically referred to as encoder network.

In an embodiment, for the two competing SKUs/products based on the number of branches to reach the common ancestor in the taxonomy, the position-separate constraint is introduced. If the retail shelf has n number of units/columns in a row and has m rows, then two products that have immediate common ancestors are constrained to be at least one row apart or at least one column apart. In an embodiment, for the two visually similar SKUs/products, the position-separate constraint is introduced. If the retail shelf has n number of units/columns in a row and has m rows, then two products that have immediate common ancestors are constrained to be at least one row apart or at least one column apart. then the products are constrained to be at least 1 row apart or at least c column apart.

In an embodiment, the position-constrains which represent which two products can be close-by and which two products have to be far-apart) are encoded as of a mathematical formulation. Accordingly, every position on the shelf which includes row-number, column-number, depth-number is modeled as a binary variable for each unit of an SKU represented as variable x_{s,i,j,k}. If a binary variable is 1 for an SKU ‘s’, then one unit of that SKU is to be kept at the corresponding shelf position at row ‘i’, column lj', depth ‘k’. An unit of a particular SKU ‘s’ in row 1 and depth 1 is modeled as x_{s,i,j,k}=0. If ‘i’ is not equal to 1, and ‘k’ is not equal not equal to 1, SKU ‘s’ and SKU ‘s′’ which are competing/visually similar have to be at least 4 rows farther and 2 columns farther (x_{s,i,j,k}-x_{s′,i+4,j,k}>0 and x_{s,i,j,k}-x_{s′,i,j+2,k}>0) or (x_{s,i+4,j,k}-x_{s′,i,j,k}>0 and x_{s,i,j+2,k}-x_{s′,i,j,k}>0).

In an embodiment, the product rearrangement includes a dynamic programming to minimize the number of moves required to move the products on the shelf in order to take a shelf configuration from a configuration 1 to a configuration 2. The dynamic programming is explained by representing configuration 1 as C1 and representing configuration 2 as C2 which are three-dimensional matrices where each position i,j,k (where i is a row, j is a column, k is a depth) indicates an SKU ‘S’. Assuming a buffer space that can hold a product and a product bin with a product distributor that has an infinite supply of all the SKUs. Case 1: S1 at position il,j1,k1 in C1 is to be swapped with S2 at position i2,j2,k2 in C2. In this case, the dynamic programming puts Si on the buffer space, replace S1 by S2 and replace S2 by Si. Case 2: S1 at position il,j1,k1 in C1 is to be replaced by S2 from the product bag the dynamic programming takes down S1 and bring up S2. The dynamic programming starts scanning C1 i,j,k from 1,1,1 position. Suppose SKU at i,j,k is S. Checks if S is the same as the expected S in C2. If S is to be replaced by S′ as part of C2 and if S′ is present in the shelf, then it goes to case 1. If S is to be replaced by S′ as part of C2 and if S′ is not present in the shelf, S′ from the product bin will be taken out. The scanning will be continued until the n,m,l position (i.e.) end of the shelf).

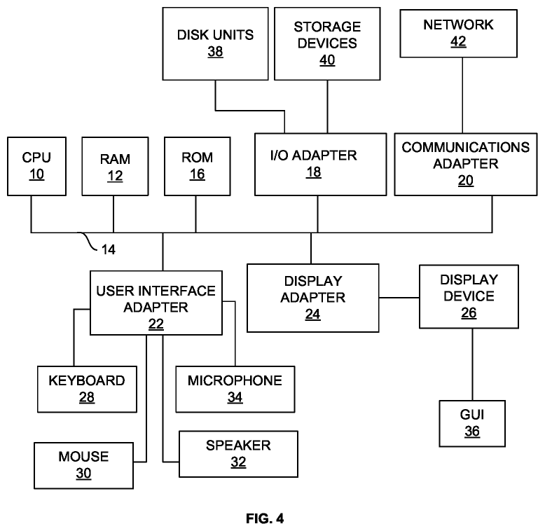

A representative hardware environment for practicing the embodiments herein is depicted in FIG. 4, with reference to FIGS. 1 through 3. This schematic drawing illustrates a hardware configuration of a server/computer system/computing device in accordance with the embodiments herein. The system includes at least one processing device CPU 10 that may be interconnected via system bus 14 to various devices such as a random access memory (RAM) 12, read-only memory (ROM) 16, and an input/output (UO) adapter 18. The I/O adapter 18 can connect to peripheral devices, such as disk units 38 and program storage devices 40 that are readable by the system. The system can read the inventive instructions on the program storage devices 40 and follow these instructions to execute the methodology of the embodiments herein. The system further includes a user interface adapter 22 that connects a keyboard 28, mouse 30, speaker 32, microphone 34, and/or other user interface devices such as a touch screen device (not shown) to the bus 14 to gather user input. Additionally, a communication adapter 20 connects the bus 14 to a data processing network 42, and a display adapter 24 connects the bus 14 to a display device 26, which provides a graphical user interface (GUI) 36 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications without departing from the generic concept, and, therefore, such adaptations and modifications should be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

We claim:

1. A processor implemented method of automatically recognizing a plurality of assets in an environment using an image recognition technique, determining a distribution of the plurality of assets, computing position adjacency constraints for the distribution of the plurality of assets and a rearrangement plan based on the position adjacency constraints for the plurality of assets in the environment, wherein the method comprising:
generating a database with a media content associated with an environment, wherein the media content is captured using a camera or a virtual reality device;
automatically determining at least one attribute of at least one object associated with a brand within the environment using a deep neural networking model, wherein the at least one attribute comprises a color, a color contrast, a location of the object, a text size, or a number of words in a text;
automatically implementing at least one compliance rule to the at least one attribute of the at least one object to determine at least one of a placement of the brand in an asset, a placement of the brand along with other brands in the asset, a number of words in the text, a size of a brand logo or a brand name, a location of the brand logo or the brand name, a color contrast of the brand with respect to the environment, or a distinctness of the brand;
automatically computing a position adjacency constraint for a distribution of a plurality of assets within the environment, wherein the computing a position adjacency constraints for the distribution of the plurality of assets comprising (a) determining two competing brands based on a brand taxonomy, wherein the competing brands have a common ancestor in the taxonomy; (b) determining, using an unsupervised neural network model, two visually similar brands and computing a similarity-score for the two visually similar brands, wherein the similarity-score is computed by determining the distance/angle between the corresponding n-bit/float vectors of the two visually similar brands within the media content; (c) introducing a position-separation constraint of least one row apart or at least one column apart of the two competing brands and the visually similar brands, wherein the position-separation constraint is encoded as a mathematical formulation by modeling each position as a binary variable; and
automatically computing a rearrangement plan for the plurality of assets within the environment based on the computed position adjacency constraint and the compliance rules.

2. The processor implemented method as claimed in claim 1, wherein the at least one object is determined by
automatically determining the distribution of the plurality of assets within the media content associated with the environment;
automatically determining a type of each of the plurality of assets within the media content;
automatically determining, using the deep neural networking model, the brand from each of the plurality of assets;
automatically determining the at least one object from the brand associated with each of the plurality of assets, wherein the at least one object comprises at least one of the brand name, the brand logo, a text, a product, or a brand specific object, wherein the method further comprises automatically extracting a plurality of images by parsing the media content when the media content comprises the video of the asset or the video of at least one of the physical retail store environments, the digital retail store environment, the virtual reality store environment, the social media environment or the web page environment.

3. The processor implemented method as claimed in claim 1, wherein the media content comprises at least one of an image of an asset, a video of an asset or a three-dimensional model of at least one of a physical retail store environment, a digital retail store environment, a virtual reality store environment, a social media environment or a web page environment, wherein the media content comprises an image or a video or three-dimensional model associated with at least one of an inside or an outside of the environment.

4. The processor implemented method as claimed in claim 1, wherein the media content is converted into a three-dimensional model when the media content is received from the digital retail store environment or the virtual reality store environment.

5. The processor implemented method as claimed in claim 1, wherein at least one compliance rule comprises at least one of a placement compliance rule, a location compliance rule, a text compliance rule, a color compliance rule, or a size compliance rule.

6. The processor implemented method as claimed in claim 1, wherein the deep neural networking model is trained using a plurality of design creatives taken at a plurality of instances corresponding to a plurality of brands.

7. The processor implemented method as claimed in claim 1, wherein the brand taxonomy is created by collecting information from organization/brand web pages.

8. The processor implemented method as claimed in claim 1, wherein the unsupervised neural network model comprises an auto-encoder to compute a fixed-length representation of the 3D/2D model/photo of each product in terms of n-bit/float vectors for calculating the similarity score.

9. One or more non-transitory computer readable storage mediums storing instructions, which when executed by a processor, causes automatic recognition of a plurality of assets in an environment using an image recognition technique, determining a distribution of the plurality of assets, computing position adjacency constraints for the distribution of the plurality of assets and a rearrangement plan based on the position adjacency constraints for the plurality of assets in the environment, by performing the steps of:
generating a database with a media content associated with an environment, wherein the media content is captured using a camera or a virtual reality device;
automatically determining at least one attribute of at least one determined object associated with a brand within the environment using a deep neural networking model, wherein the at least one attribute comprises a color, a color contrast, a location of the object, a text size, or a number of words in a text;
automatically implementing at least one compliance rule to the at least one attribute of the at least one object to determine at least one of a placement of the brand in an asset, a placement of the brand along with other brands in the asset, a number of words in the text, a size of a brand logo or a brand name, a location of the brand logo or the brand name, a color contrast of the brand with respect to the environment, or a distinctness of the brand;
automatically computing a position adjacency constraint for a distribution of plurality of assets within the environment, wherein the computing a position adjacency constraints for the distribution of the plurality of assets comprising (a) determining two competing brands based on a brand taxonomy, wherein the competing brands have a common ancestor in the taxonomy; (b) determining, using an unsupervised neural network model, two visually similar brands and computing a similarity-score for the two visually similar brands, wherein the similarity-score is computed by determining the distance/angle between the corresponding n-bit/float vectors of the two visually similar brands within the media content; (c) introducing a position-separation constraint of least one row apart or at least one column apart of the two competing brands and the visually similar brands, wherein the position-separation constraint is encoded as a mathematical formulation by modeling each position as a binary variable; and
automatically computing a rearrangement plan for the plurality of assets within the environment based on the computed position adjacency constraint and the compliance rules.

10. The one or more non-transitory computer readable storage mediums storing instructions as claimed in claim 9, wherein the at least one object is determined by
automatically determine the distribution of the plurality of assets within the media content associated with the environment;
automatically determine a type of each of the plurality of assets within the media content;
automatically determine, using the deep neural networking model, the brand from each of the plurality of assets;
automatically determine the at least one object from the brand associated with each of the plurality of assets, wherein the at least one object comprises at least one of the brand name, the brand logo, a text, a product, or a brand-specific object,
wherein when executed by the processor, further causes automatic extraction of a plurality of images by parsing the media content when the media content comprises the video of the asset or the video of at least one of the physical retail store environments, the digital retail store environment, the virtual reality store environment, the social media environment or the web page environment.

11. The one or more non-transitory computer readable storage mediums storing instructions as claimed in claim 9, wherein the media content comprises at least one of an image of an asset, a video of an asset or a three-dimensional model of at least one of a physical retail store environment, a digital retail store environment, a virtual reality store environment, a social media environment or a web page environment, wherein the media content is converted into a three-dimensional model when the media content is received from the digital retail store environment or the virtual reality store environment.

12. The one or more non-transitory computer readable storage mediums storing instructions as claimed in claim 9, wherein the media content comprises an image or a video or three-dimensional model associated with at least one of inside or outside of the environment.

13. The one or more non-transitory computer readable storage mediums storing instructions as claimed in claim 9, wherein the deep neural networking model is trained using a plurality of design creatives taken at a plurality of instances corresponding to a plurality of brands.

14. The one or more non-transitory computer readable storage mediums storing instructions as claimed in claim 9, wherein at least one compliance rule comprises at least one of a placement compliance rule, a location compliance rule, a text compliance rule, a color compliance rule, or a size compliance rule.

15. The one or more non-transitory computer readable storage mediums storing instructions as claimed in claim 9, wherein the brand taxonomy is created by collecting information from organization/brand web pages.

16. The one or more non-transitory computer readable storage mediums storing instructions as claimed in claim 9, wherein the unsupervised neural network model comprises an auto-encoder to compute a fixed length representation of the 3D/2D model/photo of each product in terms of n-bit/float vectors for calculating the similarity score.

17. A system for automatically recognizing a plurality of assets in an environment using an image recognition technique, determining a distribution of the plurality of assets, computing position adjacency constraint for the distribution of the plurality of assets and a rearrangement plan based on the position adjacency constraints for the plurality of assets in the environment, wherein the system comprising:
a memory that stores a database (201) and a set of modules;
a device processor that executes said set of modules, wherein said set of modules comprise:
a database generation module (202) that generates a database of media content associated with the environment, wherein the media content is captured using a camera or a virtual reality device, wherein the media content comprises at least one of an image of an asset, a video of an asset or a three-dimensional model of at least one of a physical retail store environment, a digital retail store environment, a virtual reality store environment, a social media environment or a web page environment;
an asset determination module (204) that determines (i) a distribution of a plurality of assets within the media content associated with the environment, and (ii) a type of each of the plurality of assets within the media content;
a brand determination module (206) that determines, using a deep neural network model, a brand from each of the plurality of assets;
an object recognition module (208) that determines at least one object from the brand associated with each of the plurality of assets, wherein at least one object comprises at least one of a brand name, a brand logo, a text, a product, or a brand-specific object;
an attribute determination module (210) that determines at least one attribute of the at least one determined object associated with the brand within the environment using the deep neural networking model, wherein at least one attribute comprises a color, a color contrast, a location of the object, a text size, or a number of words in the text;
a compliance rule implementation module (212) that implements at least one compliance rule to the at least one attribute of the at least one object to determine at least one of a placement of the brand in the asset, a placement of the brand along with other brands in the asset, a number of words in the text, a size of the brand logo or the brand name, a location of the brand logo or the brand name, a color contrast of the brand with respect to the environment, or a distinctness of the brand;
a position adjacency constraint computation module (214), that computes a position adjacency constraints for the distribution of the plurality of assets comprising (a) determining two competing brands based on a brand taxonomy, wherein the competing brands have a common ancestor in the taxonomy; (b) determining, using an unsupervised neural network model, two visually similar brands and computing a similarity-score for the two visually similar brands, wherein the unsupervised neural network model comprises an auto-encoder to compute a fixed-length representation of the 3D/2D model/photo of each product in terms of n-bit/float vectors for calculating the similarity score; (c) introducing a position-separation constraint of least one row apart or at least one column apart of the two competing brands and the visually similar brands, wherein the position-separation constraint is encoded as a mathematical formulation by modeling each position as a binary variable; and
a rearrangement plan computation module (216) that computes a rearrangement plan for the plurality of assets within the environment based on the computed position adjacency constraint and the compliance rules.

18. The system as claimed in claim 17, wherein the one or more modules comprises a parsing module that automatically extracts a plurality of images by parsing the media content when the media content comprises the video of the asset or the video of at least one of the physical retail store environments, the digital retail store environment, the virtual reality store environment, the social media environment or the web page environment.

19. The system as claimed in claim 16, wherein the brand taxonomy is created by collecting information from organization/brand web pages.

20. The system as claimed in claim 16, wherein unsupervised neural network model comprises an auto-encoder to compute a fixed-length representation of the 3D/2D model/photo of each product in terms of n-bit/float vectors for calculating the similarity score.
